(19) United States
(12) Patent Application Publication
(10) Pub. No.: US 2009/0182781 A1
(43) Pub. Date: Jul. 16, 2009

(54) DATA OBJECT LOGGING

(76) Inventor: Harikrishnan Kesavan Nair, K.K. District (IN)

Correspondence Address: HOFFMAN WARNICK LLC, 75 STATE ST, 14TH FLOOR, ALBANY, NY, 12207, US

(21) Appl. No.: 11/972,758

(22) Filed: Jan. 11, 2008

(51) Int. Cl. G06F 17/30

(52) U.S. Cl. 707/202; 707/E17.007

(57) ABSTRACT

The invention provides a method, system, and program product for logging the contents of a data object.

### TECHNICAL FIELD

The invention relates generally to data processing and, more particularly, to a method, system, and program product for logging the contents of a data object by iterating through its attributes.

### BACKGROUND OF THE INVENTION

Most data networks employ logging procedures, whereby network- or application-related information is recorded in response to some predefined event. For example, information associated with a user (e.g., username, password, IP address, etc.) may be logged when he or she connects to a particular server in a network. However, the information to be logged in such cases must be pre-defined. That is, the information logged is only that information specified in a log string passed to a logging program. If a particular data object includes potentially useful information that is not specified in the log string, that information is not logged by the logging program. As a result, potentially useful information is lost.

The inability of existing logging systems and methods to log useful information is especially problematic in the case of nested data objects (i.e., a data object containing, as one of its own attributes, another data object or objects). Nesting of data objects is quite common and, in some cases, involves a high degree of nesting (i.e., nested data objects themselves contain other data objects, which contain other nested data objects, etc.). Using existing systems and methods, this nesting would have to be specified in the log string passed to the logging program, requiring advanced, extensive knowledge of the data object's structure. In addition, changes to one or more attributes of a data object must be reflected in a revised log string and/or manually changed in the existing log of the data object. In some cases, an attribute (e.g., nested data object) may be common to a number of data objects, requiring changes in multiple log strings or existing logs.

Accordingly, there exists a need in the art to overcome the deficiencies and limitations described hereinabove.

### SUMMARY OF THE INVENTION

The invention provides a method, system, and program product for logging the contents of a data object.

A first aspect of the invention provides a method of logging contents of a data object, the method comprising: accessing a data object; iterating through the data object's attributes; logging the data object's contents; and outputting the logged contents.

A second aspect of the invention provides a system for logging contents of a data object, the system comprising: a system for accessing a data object; a system for iterating through the data object's attributes; a system for logging the data object's contents; and a system for outputting the logged contents.

A third aspect of the invention provides a program product stored on a computer-readable medium, which when executed, logs contents of a data object, the program product comprising: program code for accessing a data object; program code for iterating through the data object's attributes; program code for logging the data object's contents; and program code for outputting the logged contents.

A fourth aspect of the invention provides a method for deploying an application for logging contents of a data object, comprising: providing a computer infrastructure being operable to: access a data object; iterate through the data object's attributes; log the data object's contents; and output the logged contents.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a first data object nested within a second data object.

FIG. 2 shows an illustrative extensible markup language (XML) output log according to an embodiment of the invention.

FIG. 3 shows a flow diagram of an illustrative method according to an embodiment of the invention.

FIG. 4 shows a block diagram of an illustrative system according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

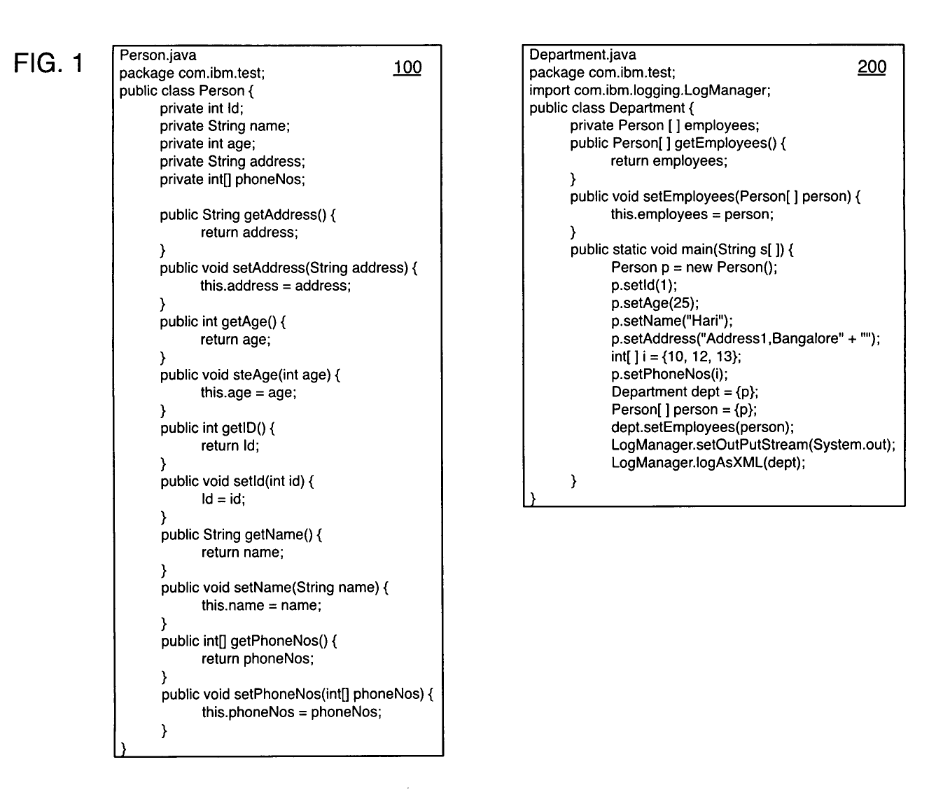

As explained above, the present invention provides a method, system, and program product for logging the contents of a data object. Turning to the drawings, FIG. 1 shows a first data object 100 “nested” within a second data object 200. Here, the first and second data objects 100, 200 are JAVABEANS® (Sun Microsystems), although the present invention is applicable to any object type. Indeed, one advantage of the present invention is that the data object to be logged may be of any type, including an unknown type.

Still referring to FIG. 1, upon logging the second data object 200 (a department BEAN), the present invention includes an iteration of the contents of the second data object 200, such that the resulting log includes not only the attributes of the second data object 200, but also the attributes of the first data object 100 (a person BEAN).

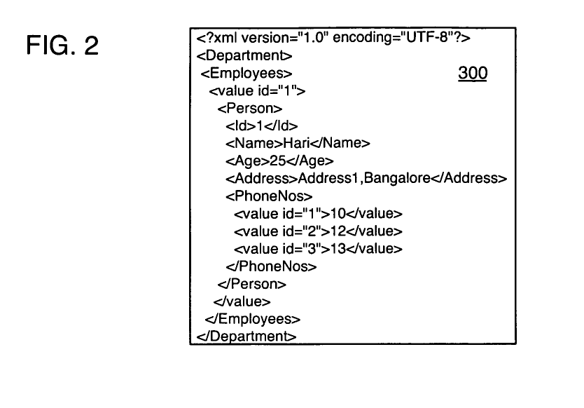

FIG. 2 shows a resulting extensible markup language (XML) log file 300 following the logging of the second data object 200 (FIG. 1) according to the invention. As can be seen, log file 300 includes contents of the first and second data objects 100, 200 (FIG. 1) and maintains their “nested” relationship. As noted above, one advantage of the present invention over existing logging methods and systems is that changes to individual nested data objects need not be reflected in an input log string. That is, a change to an attribute of a data object, even where that change includes the addition, deletion, or alteration of a nested data object, will be reflected in a subsequent log of the data object without any change to an input log string (as in existing logging methods and systems) or even knowledge of the change.

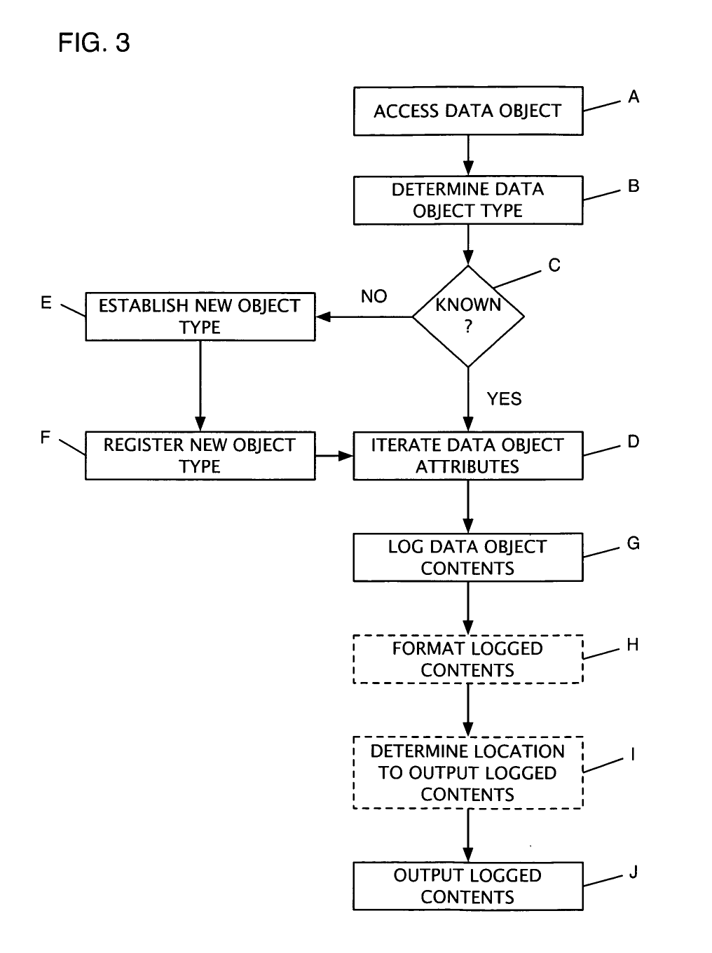

FIG. 3 shows a flow diagram of an illustrative method according to one embodiment of the invention. At A, a data object is accessed. At B, the object type of the data object is determined and at C, it is determined whether the object type of the data object is known. If so, i.e., YES at C, the attributes of the data object are iterated at D, such that the attributes of nested data objects, if any, are also determined. If not, i.e., NO at C, a new object type based on the data object may be established at E and the new object type registered with the logger at F. Once the new object type is established and registered at E and F, the attributes of the data object are iterated at D.

At G, the contents of the data object are logged. At H, the contents logged at G may optionally be formatted. As noted above, XML is one possible format for the logged contents, although this is not essential. Other known or later-developed formats may also be used. At I, a location to which logged contents are to be outputted may optionally be determined. While shown following G and/or H, it should be understood that this may occur at any point prior to the actual outputting of the logged contents at J.

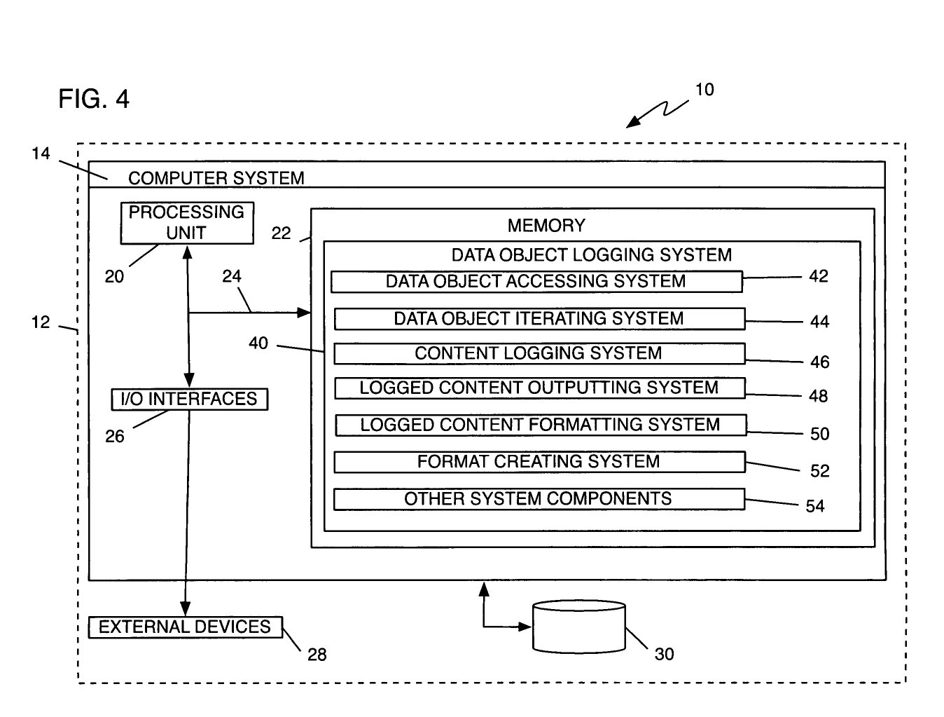

FIG. 4 shows an illustrative system 10 for logging a data object. To this extent, system 10 includes a computer infrastructure 12 that can perform the various process steps described herein for logging a data object. In particular, computer infrastructure 12 is shown including a computer system 14 that comprises a data object logging system 40, which enables computer system 14 to log the contents of a data object by performing the process steps of the invention.

Computer system 14 is shown including a processing unit 20, a memory 22, an input/output (I/O) interface 26, and a bus 24. Further, computer system 14 is shown in communication with external devices 28 and a storage system 30. As is known in the art, in general, processing unit 20 executes computer program code, such as data object logging system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and data object logging system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, data object logging system 40 enables computer system 14 to log the contents of a data object. To this extent, data object logging system 40 is shown including a data object accessing system 42, a data object iterating system 44, a content logging system 46, a logged content outputting system 48, a logged content formatting system 50, and a format creating system 52. Operation of each of these systems is discussed above. Data object logging system 40 may further include other system components 54 to provide additional or improved functionality to data object logging system 40. It is understood that some of the various systems shown in FIG. 4 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for logging the contents of a data object, it is understood that the invention further provides various alternative embodiments. For example, in one embodiment, the invention provides a computer-readable medium that includes computer program code to enable a computer infrastructure to log the contents of a data object. To this extent, the computer-readable medium includes program code, such as data object logging system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to log the contents of a data object, as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for logging the contents of a data object. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of logging contents of a data object, the method comprising:
accessing a data object;
iterating through the data object's attributes;
logging the data object's contents; and
outputting the logged contents.

2. The method of claim 1, further comprising:
determining a location in which to output the logged contents.

3. The method of claim 1, further comprising:
formatting the logged contents.

4. The method of claim 3, further comprising:
defining the format of the logged contents.

5. The method of claim 4, further comprising:
creating a new format for the logged contents.

6. The method of claim 3, wherein formatting includes formatting the logged contents in extensible markup language (XML).

7. The method of claim 1, further comprising:
determining an object type of the data object.

8. The method of claim 7, wherein, in the case that the object type of the data object is unknown, the method further comprises:
establishing a new object type based on the data object; and
registering the new object type.

9. A system for logging contents of a data object, the system comprising:
a system for accessing a data object;
a system for iterating through the data object's attributes;
a system for logging the data object's contents; and
a system for outputting the logged contents.

10. The system of claim 9, further comprising:
a system for formatting the logged contents.

11. The system of claim 10, further comprising:
a system for defining the format of the logged contents; and
a system for creating a new format for the logged contents.

12. The system of claim 9, further comprising:
a system for determining an object type of the data object;
a system for establishing a new object type based on the data object; and
a system for registering the new object type.

13. A program product stored on a computer-readable medium, which when executed, logs contents of a data object, the program product comprising:
program code for accessing a data object;
program code for iterating through the data object's attributes;
program code for logging the data object's contents; and
program code for outputting the logged contents.

14. The program product of claim 13, further comprising:
program code for formatting the logged contents.

15. The program product of claim 14, further comprising:
program code for defining the format of the logged contents; and
program code for creating a new format for the logged contents.

16. The program product of claim 13, further comprising:
program code for determining an object type of the data object.

17. The program product of claim 16, further comprising:
program code for establishing a new object type based on the data object; and
program code for registering the new object type.

18. A method for deploying an application for logging contents of a data object, comprising:
providing a computer infrastructure being operable to:
access a data object;
iterate through the data object's attributes;
log the data object's contents; and
output the logged contents.

19. The method of claim 18, wherein the computer infrastructure is further operable to:
format the logged contents.

20. The method of claim 18, wherein the computer infrastructure is further operable to:
determine an object type of the data object;
establish a new object type based on the data object; and
register the new object type.
